(19) United States
(12) Patent Application Publication
(10) Pub. No.: US 2009/0210361 A1
(43) Pub. Date: Aug. 20, 2009

(54) MULTI-PLATFORM CONTROL SYSTEM FOR CONTROLLING MACHINES

(76) Inventor: Shiqing Chen, Chengdu (CN)

Correspondence Address: MATTHIAS SCHOLL, 14781 MEMORIAL DRIVE, SUITE 1319, HOUSTON, TX, 77079, US

(21) Appl. No.: 12/389,326

(22) Filed: Feb. 19, 2009

(30) Foreign Application Priority Data
Feb. 20, 2008 (CN) 200810045381.X

(51) Int. Cl. G06N 5/02; G06F 15/16

(52) U.S. Cl. 706/10; 706/46; 709/203

(57) ABSTRACT

Provided is a multi-platform control system, comprising a machine with a first artificial-intelligence module, a terminal machine with a second artificial-intelligence module, a first server with a third artificial-intelligence module, and a second server with a fourth artificial-intelligence module; wherein the first server is connected between the second server and the machine, and between the second server and the terminal machine; the second artificial-intelligence module analyzes data from a user and transfers the analyzed data to the first server; the third artificial-intelligence module determines whether the data can be processed, transfers the data to the first server if the data cannot be processed; the first artificial-intelligence module drives the machine to operate according to the instruction from the third artificial-intelligence module; and the fourth artificial-intelligence module processes the data from the third artificial-intelligence module and transfers the processed data to the first server.

### CROSS-REFERENCE TO RELATED APPLICATIONS

Pursuant to 35 U.S.C. §119 and the Paris Convention Treaty, this application claims the benefit of Chinese Patent Application No. 200810045381.X filed Feb. 20, 2008, the contents of which are incorporated herein by reference.

### BACKGROUND OF THE INVENTION

1. Field of the Invention

The invention relates to a wireless communication system, and particularly to a multi-platform control system for controlling machines.

2. Description of the Related Art

Conventionally, a multi-platform communication system comprises a terminal machine (such as a mobile phone, a handset, etc.), a machine (such as a TV set), and a server. As a user sends an instruction via the terminal machine, the server processes the instruction and then transfers the instruction to the machine, so as to enable the machine to operate according to the instruction. However, conventional multi-platform communication systems are incapable of handling complex data from a user, and have poor cross-platform compatibility.

### SUMMARY OF THE INVENTION

In view of the above-described problems, it is one objective of the invention to provide a multi-platform control system that is capable of handling complex data from a user and features good cross-platform compatibility.

In order to achieve the above objectives, in accordance with one embodiment of the invention, provided is a multi-platform control system, comprising a machine with a first artificial-intelligence module, a terminal machine with a second artificial-intelligence module, a first server with a third artificial-intelligence module, and a second server with a fourth artificial-intelligence module; wherein the first server is connected between the second server and the machine, and between the second server and the terminal machine; the second artificial-intelligence module analyzes data from a user and transfers the analyzed data to the first server; the third artificial-intelligence module determines whether the data can be processed, transfers an instruction to the machine according to the data and processes and transfers the data to the terminal machine if the data can be processed, or transfers the data to the first server if the data cannot be processed; the first artificial-intelligence module drives the machine to operate according to the instruction from the third artificial-intelligence module; and the fourth artificial-intelligence module processes the data from the third artificial-intelligence module and transfers the processed data to the first server.

In a class of this embodiment or in another embodiment, the third artificial-intelligence module transfers an instruction to the machine according to the data processed by the fourth artificial-intelligence module and the data to the terminal machine.

In a class of this embodiment or in another embodiment, the first server is connected to an external database for obtaining updated data therefrom.

In a class of this embodiment or in another embodiment, the terminal machine is a personal computer, a laptop, a mobile phone, or a music player.

In a class of this embodiment or in another embodiment, the data are video data or voice data.

In a class of this embodiment or in another embodiment, the machine is a home appliance having a specially assigned identification number.

In a class of this embodiment or in another embodiment, the machine is connected to the second server via a wireless network.

In a class of this embodiment or in another embodiment, the first server is an integrated server.

In a class of this embodiment or in another embodiment, the second server is a super server.

Advantages of the Invention Comprise:
1. The system can handle different data from a user, such as voice, video and so on.
2. Two-way information exchange: after the data from a user is processed, an instruction is sent to the user.
3. Four artificial-intelligence modules operate with each other and greatly improve operation efficiency of the system.
4. Good applicability and high scalability.

### BRIEF DESCRIPTION OF THE DRAWINGS

FIG. 1 is a schematic diagram of a multi-platform control system of an exemplary embodiment of the invention;

FIG. 2 is a block diagram of an application of the invention;

FIG. 3 is a block diagram of another application of the invention;

FIG. 4 is a block diagram of a further application of the invention; and

FIG. 5 is a block diagram of a still further application of the invention

### DETAILED DESCRIPTION OF THE EMBODIMENTS

Detailed description will be given below in conjunction with accompanying drawings.

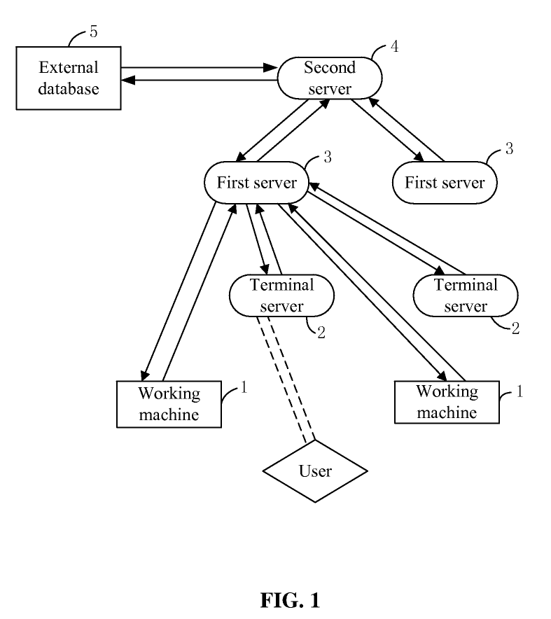

As shown in FIG. 1, a multi-platform control system comprises a machine 1 with a first artificial-intelligence module 11, a terminal machine 2 with a second artificial-intelligence module 21, a first server 3 with a third artificial-intelligence module 31, and a second server 4 with a fourth artificial-intelligence module 41. In this embodiment, the first server 3 is an integrated server, the second server 4 is a super server, the terminal machine 2 is a personal computer, a laptop, a mobile phone, or a music player, and the machine 1 is a home appliance having a specially assigned identification number.

The first server 3 is connected between the second server 4 and the machine 1, and between the second server 4 and the terminal machine 2.

The first server 3 is connected to an external database 5 for obtaining updated data therefrom.

The second artificial-intelligence module 21 analyzes data from a user and transfers the analyzed data to the first server 3.

The third artificial-intelligence module 31 determines whether the data can be processed. If the data can be processed, the third artificial-intelligence module 31 transfers an instruction to the machine 1 according to the data, and processes and transfers the data to the terminal machine 2. If the data cannot be processed, the third artificial-intelligence module 31 transfers the data to the second server 4.

The fourth artificial-intelligence module 41 processes the data from the third artificial-intelligence module 31 and transfers the processed data to the first server 3.

The first artificial-intelligence module 11 drives the machine 1 to operate according to the instruction from the third artificial-intelligence module 31.

In this embodiment, the data are voice data or video data.

Operation Principle of the Invention is as Follows:

After a user transfers data via the terminal machine 2, the second artificial-intelligence module 21 analyzes the data and transfers the analyzed data to the first server 3. The third artificial-intelligence module 31 determines whether the data can be processed.

If the data can be processed, the third artificial-intelligence module 31 transfers an instruction to the machine 1 according to the data, and processes and transfers the data to the terminal machine 2. The first artificial-intelligence module 11 drives the machine 1 to operate according to the instruction from the third artificial-intelligence module 31.

If the data cannot be processed, the third artificial-intelligence module 31 transfers the data to the second server 4. The fourth artificial-intelligence module 41 processes the data from the third artificial-intelligence module 31 and transfers the processed data to the first server 3. The third artificial-intelligence module 31 transfers an instruction to the machine 1 according to the data processed by the fourth artificial-intelligence module 41 and the data to the terminal machine 2. The first artificial-intelligence module 11 drives the machine 1 to operate according to the instruction from the third artificial-intelligence module 31.

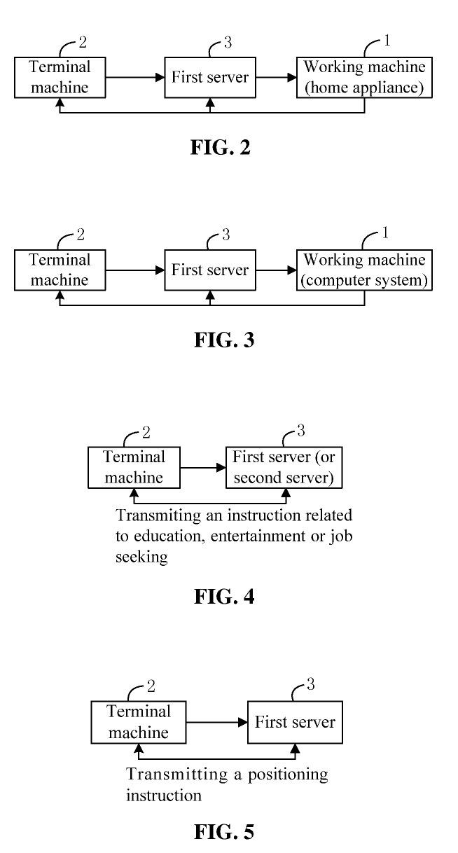

As shown in FIG. 2, an intelligent home environment is illustrated. A user transmits data via the terminal machine 2, the second artificial-intelligence module 21 analyzes the data and transfers the analyzed data to the first server 3, and then the first server 3 transfers an instruction to a home appliance according to the data, and processes and transfers data to the terminal machine 2.

As shown in FIG. 3, an intelligent secretarial system is illustrated. After a user transmits an instruction related to a working schedule, the system searches relevant data in a working software and returns retrieved data to the user.

As shown in FIG. 4, an information-sharing system is illustrated. After a user transmits an instruction related to education, entertainment or job seeking, the system provides the corresponding resource in a shared manner.

As shown in FIG. 5, a navigation environment is illustrated. After a user transmits a positioninglocation, the system searches address and position information according via a GPS satellite and provides retrieved data back to the user.

Functions of the system can be extended as long as a peripheral device is connected to the system or application software is installed on the system.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

The invention claimed is:

1. A multi-platform control system, comprising
a machine comprising a first artificial-intelligence module;
a terminal machine comprising a second artificial-intelligence module;
a first server comprising a third artificial-intelligence module; and
a second server comprising a fourth artificial-intelligence module; wherein
said first server is connected between said second server and said machine, and between said second server and said terminal machine;
said second artificial-intelligence module analyzes data from a user and transfers the analyzed data to said first server;
said third artificial-intelligence module determines whether the data can be processed, transfers an instruction to said machine according to the data, and processes and transfers the data to said terminal machine if the data can be processed, or transfers the data to the second server if the data cannot be processed;
said first artificial-intelligence module drives said machine to operate according to the instruction from said third artificial-intelligence module; and
said fourth artificial-intelligence module processes the data from said third artificial-intelligence module and transfers the processed data to said first server.

2. The multi-platform control system of claim 1, wherein said third artificial-intelligence module transfers an instruction to said machine according to the data processed by said fourth artificial-intelligence module and the data to said terminal machine.

3. The multi-platform control system of claim 1, wherein said first server is connected to an external database for obtaining updated data therefrom.

4. The multi-platform control system of claim 1, wherein said terminal machine is a personal computer, a laptop, a mobile phone, or a music player.

5. The multi-platform control system of claim 1, wherein said data are video data or voice data.

6. The multi-platform control system of claim 1, wherein said machine is a home appliance having a specially assigned identification number.

7. The multi-platform control system of claim 1, wherein said machine is connected to said second server via a wireless network.

8. The multi-platform control system of claim 1, wherein said first server is an integrated server.

9. The multi-platform control system of claim 1, wherein said second server is a super server.
